(19) United States
(12) Patent Application Publication
(10) Pub. No.: US 2016/0231820 A1
(43) Pub. Date: Aug. 11, 2016

(54) ELECTRONIC DEVICE AND CONTROL METHOD FOR DISPLAYING USER INTERFACE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: ZHAO-PING ZHANG, Shenzhen (CN); CHIH-SAN CHIANG, New Taipei (TW); HUI-GANG HE, Shenzhen (CN); SHENG HOU, Shenzhen (CN)

(21) Appl. No.: 14/804,737

(22) Filed: Jul. 21, 2015

(30) Foreign Application Priority Data
Feb. 9, 2015 (CN) 201510065864.6

(51) Int. Cl. G06F 3/01

(52) U.S. Cl. CPC G06F 3/017

(57) ABSTRACT

A control method for displaying a user interface of an electronic device includes obtaining movement parameters of the electronic device detected by a detection device and determining whether the movement of the electronic device is caused by a tilting operation. If the movement of the electronic device is caused by a tilting operation, an interrupt signal including a movement direction of the electronic device is generated. A new user interface is determined and switched to be displayed on the display screen if an amount of multiple continuous interrupt signals including a same movement direction is more than a preset value within a first preset time.

### CROSS-REFERENCE TO RELATED APPLICATIONS

This application claims priority to Chinese Patent Application No. 201510065864.6 filed on Feb. 9, 2015, the contents of which are incorporated by reference herein.

### FIELD

The subject matter herein generally relates to an electronic device and a control method for displaying a user interface.

### BACKGROUND

User interfaces can be switched in response to an operation on a touch screen.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device including a control system.

FIG. 2 illustrates a diagrammatic view of one embodiment of multiple user interfaces stored in the electronic device of FIG. 1.

FIG. 3 illustrates a diagrammatic view of one embodiment of a current user interface displayed on the electronic device of FIG. 1.

FIG. 4 illustrates a diagrammatic view of one embodiment of a tilting state of the electronic device of FIG. 1.

FIG. 5 illustrates a diagrammatic view of another embodiment of a tilting state of the electronic device of FIG. 1.

FIG. 6 illustrates a diagrammatic view of one embodiment of a second user interface displayed on the electronic device of FIG. 1.

FIG. 7 illustrates a flowchart of one embodiment of a control method for displaying user interface on the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in details so as not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

Furthermore, the term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media includes CDs, DVDs, BLU-RAY, flash memory, and hard disk drives. The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

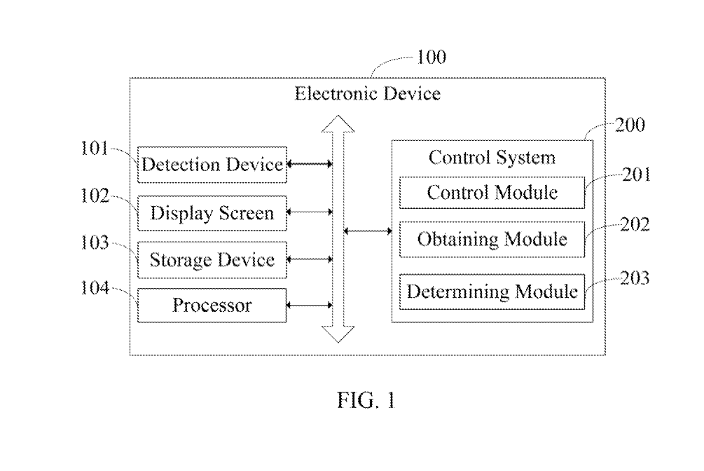

FIG. 1 illustrates a block diagram of one embodiment of an electronic device. In at least one embodiment as shown in FIG. 1, an electronic device 100 includes, but is not limited to, a detection device 101, a display screen 102, a storage device 103, at least one processor 104 and a control system 200. The electronic device 100 can be a tablet computer, a notebook computer, a smart phone, a personal digital assistant (PDA), or another suitable electronic device. FIG. 1 illustrates only one example of the electronic device 100 that can include more or fewer components than illustrated, or have a different configuration of the various components in other embodiments.

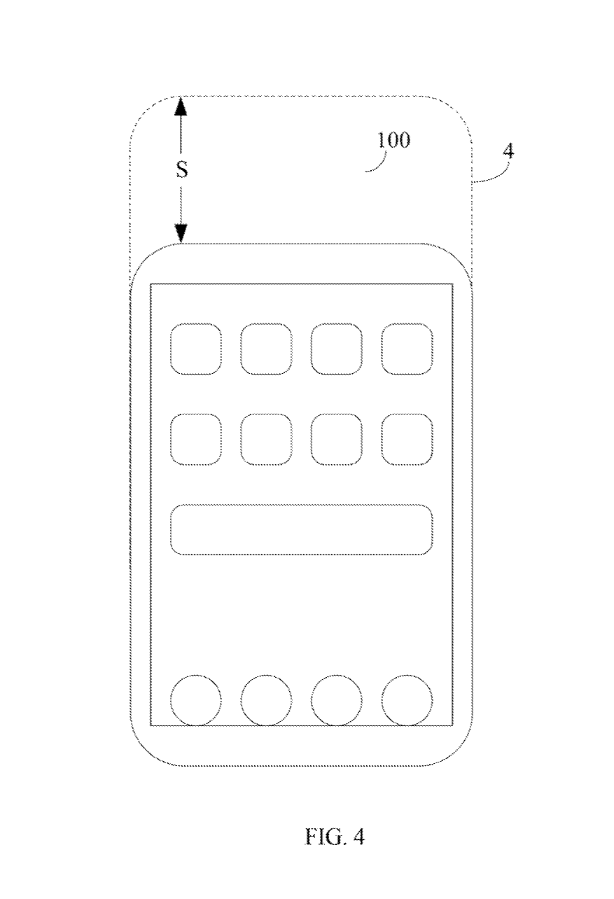

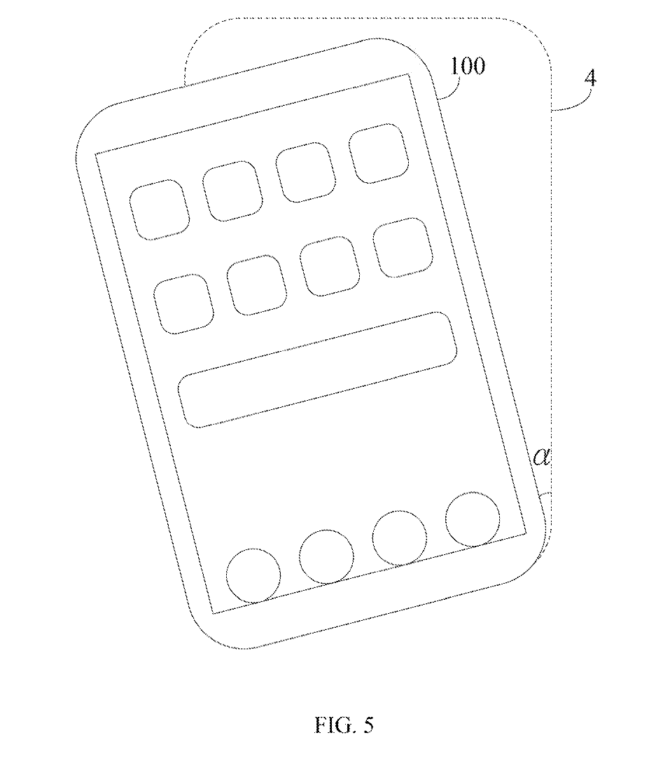

The detection device 101 can detect movement parameters of the electronic device 100. In the embodiment, the detection device 101 is an acceleration sensor, and the acceleration sensor can detect an acceleration direction of the electronic device 100 and a displacement S relatives to a reference position 4 (see FIG. 4) of the electronic device 100 in the movement direction. In other embodiments, the detection device 101 can be a gyroscope, and the gyroscope detects a movement direction and a tilt angle a relative to a reference position 4 (see FIG. 5) on a plane of the electronic device 100.

The display screen 102 can display user interface of the electronic device 100. In the embodiment, the display screen 102 is a touch screen.

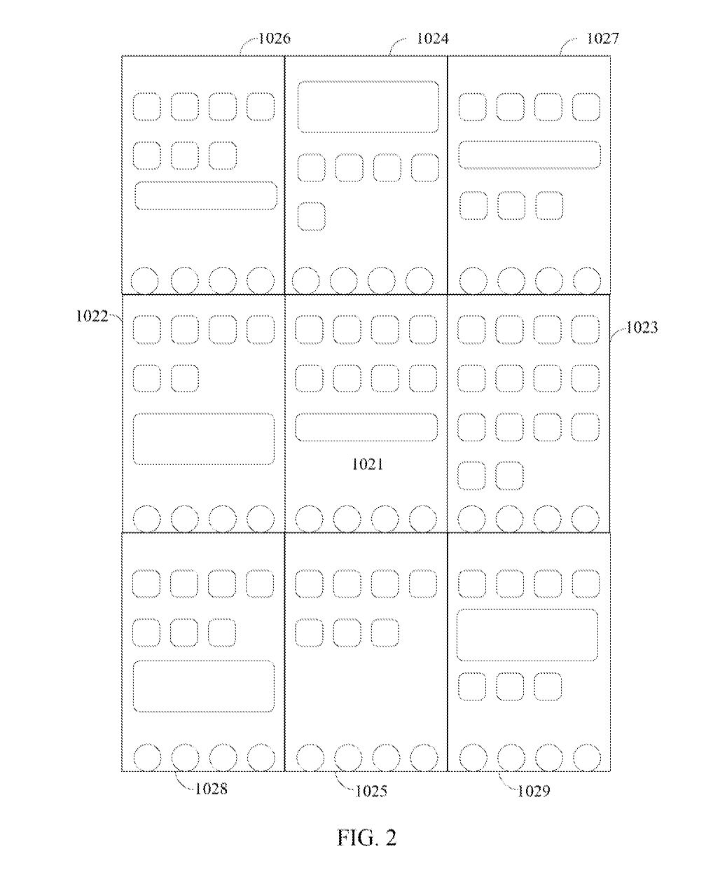

The storage device 103 can pre-store a series of instructions for user interfaces of the electronic device 100 arranged in a predetermined order. FIG. 2 illustrates that in the embodiment, the series of user interfaces include a first user interface 1021, a second user interface 1022, a third user interface 1023, a fourth user interface 1024 and a fifth user interface 1025. The second user interface 1022 is on the left side of the first user interface 1021, the third user interface 1023 is on the right side of the first user interface 1021, the fourth user interface 1024 is above the first user interface 1021, the fifth user interface 1025 is below the first user interface 1021, the sixth user interface 1026 is on the top left of the first user interface 1021, the seventh user interface 1027 is on the top right of the first user interface 1021, the eighth user interface 1028 is on the bottom left of the first user interface 1021, and the ninth user interface 1029 is on the bottom right of the first user interface 1021.

In at least one embodiment, the storage device 103 can include various types of non-transitory computer-readable storage mediums. For example, the storage device 103 can be an internal storage system, such as a flash memory, a random access memory (RAM) for temporary storage of information, and/or a read-only memory (ROM) for permanent storage of information. The storage device 103 can also be an external system, such as a hard disk, a storage card, or a data storage medium. The at least one processor 104 can be a central processing unit (CPU), a microprocessor, or other data processor chip that performs functions of the control system 200 in the electronic device 100.

The control system 200 can control the display screen 102 to display a new user interface when detecting that the electronic device 100 is titled twice towards a same direction.

In at least one embodiment, the control system 200 can include a control module 201, an obtaining module 202 and a determining module 203. The function modules 201-203 can include computerized codes in the form of one or more programs, which are stored in the storage device 103. The at least one processor 104 executes the computerized codes to provide functions of the function modules 201-203.

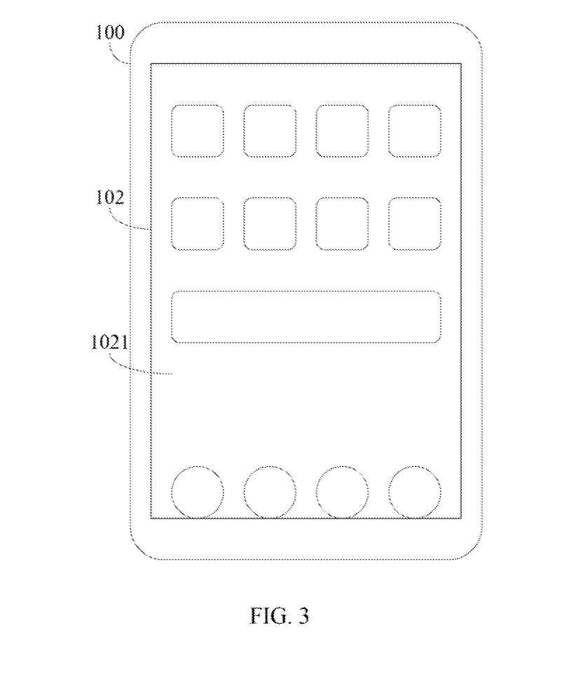

The control module 201 controls the display screen 102 to display a user interface. Referring to FIG. 3, in the embodiment, the current user interface displayed on the display screen 102 is the first user interface 1021.

The control module 201 further controls the detection device 101 to detect movement parameters of the electronic device 100. In at least one embodiment, the movement parameters include the movement direction and the displacement S relatives to the reference position 4. In other embodiments, the movement parameters can include the movement direction and the tilt angle a relative to the reference position 4.

The obtaining module 202 obtains the movement parameters detected by the detection device 101 and the determining module 203 determines whether the movement of the electronic device 100 is caused by a tilting operation according to the obtained movement parameters. In at least one embodiment, the determining module 203 determines whether the displacement S is greater than a preset displacement. If the displacement S is greater than a preset displacement, the determining module 203 further determines whether displacement S changes to be less than the preset displacement within a first preset time. If the displacement S changes to be less than the preset displacement within the first preset time, the determining module 203 determines the movement of the electronic device 100 is caused by a tilting operation. In other embodiments, the determining module 203 determines whether the tilt angle a is greater than a preset angle. If the tilt angle a is greater than the preset angle, the determining module 203 further determines whether the tilt angle a changes to be less than the preset angle within a first preset time. If the tilt angle a changes to be less than the preset angle within the first preset time, the determining module 203 determines the movement of the electronic device 100 is caused by a tilting operation.

If the movement of the electronic device 100 is caused by a tilting operation, the control module 201 generates an interrupt signal including the movement direction. The control module 201 records an amount of multiple continuous interrupt signals including a same movement direction and the determining module 203 further determines whether the amount is more than a preset value within a second preset time.

If the amount of multiple continuous interrupt signals including a same movement direction is more than the preset value within the second preset time, the determining module 203 determines a new user interface next to the current user interface displayed on the display screen 102 according to the movement direction and the predetermined order, and the control module 201 switches the current user interface displayed on the display screen 102 to the new user interface. In at least one embodiment, the preset value is two, that is to say, if the electronic device 100 is titled twice toward a same direction, such as left, or bottom, the determining module 203 determines a new user interface next to the current user interface, and the control module 201 switches the current user interface displayed on the display screen 102 to the new user interface.

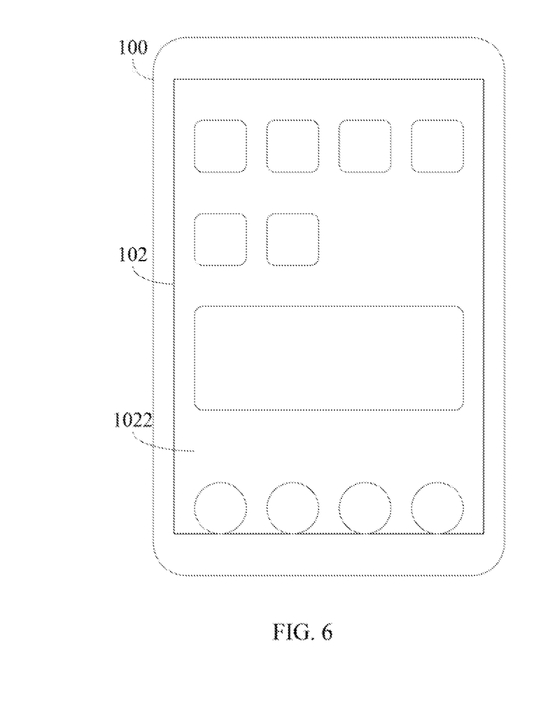

In at least one embodiment, the determining module 203 determines a user interface on the opposite direction of the movement direction of the current user interface as the new user interface. That is to say, if the movement direction is to the left of the electronic device 100, a user interface is determined on the right side of the current user interface as the new user interface; if the movement direction is to the right of the electronic device 100, a user interface is determined on the left side of the current user interface as the new user interface; if the movement direction is to the top of the electronic device 100, a user interface is determined below the current user interface as the new user interface; and if the movement direction is to the bottom of the electronic device 100, a user interface is determined above the current user interface as the new user interface. Furthermore, a user interface is determined on the bottom left of the current user interface as the new user interface if the movement direction is to the top right of the electronic device 100; a user interface is determined on the bottom right of the current user interface as the new user interface if the movement direction is to the top left of the electronic device 100; a user interface is determined on the top left of the current user interface as the new user interface if the movement direction is to the bottom right of the electronic device 100; and a user interface is determined on the top right of the current user interface as the new user interface if the movement direction is to the bottom left of the electronic device 100. For example, FIG. 3 illustrates if the current user interface displayed on the display screen 102 is the first user interface 1021, and the electronic device 100 is titled to the left twice, the determining module 203 determines the third user interface 1023 which is on the right side of the first user interface 1021 as the new user interface, the control module 201 switches the first user interface 1021 to the third user interface 1023 (see FIG. 6). If the electronic device 100 is titled to the bottom twice, the determining module 203 determines the fourth user interface 1024 which is above the first user interface 1021 as the new user interface. And if the electronic device 100 is titled to the top right twice, the determining module 203 determines the eighth user interface 1028 which is on the bottom left of the first user interface 1021 as the new user interface.

In other embodiments, the determining module 203 determines a user interface on the same direction of the movement direction of the current user interface as the new user interface. That is to say, if the movement direction is to the left of the electronic device 100, a user interface is determined on the left side of the current user interface as the new user interface; if the movement direction is to the right of the electronic device 100, a user interface is determined on the right side of the current user interface as the new user interface; if the movement direction is to the top of the electronic device 100, a user interface is determined above the current user interface as the new user interface; and if the movement direction is to the bottom of the electronic device 100, a user interface is determined below the current user interface as the new user interface. Furthermore, a user interface is determined on the top right of the current user interface as the new user interface if the movement direction is to the top right of the electronic device 100; a user interface is determined on the top left of the current user interface as the new user interface if the movement direction is to the top left of the electronic device 100; a user interface is determined on the top bottom right the current user interface as the new user interface if the movement direction is to the bottom right of the electronic device 100; and a user interface is determined on the bottom left of the current user interface as the new user interface if the movement direction is to the bottom left of the electronic device 100. For example, FIG. 3 illustrates if the current user interface displayed on the display screen 102 is the first user interface 1021, and the electronic device 100 is titled to the left twice, the determining module 203 determines the second user interface 1022 which is on the left side of the first user interface 1021 as the new user interface, the control module 201 switches the first user interface 1021 to the second user interface 1022. If the electronic device 100 is titled to the bottom twice, the determining module 203 determines the fifth user interface 1025 which is below the first user interface 1021 as the new user interface. And if the electronic device 100 is titled to the top right twice, the determining module 203 determines the seventh user interface 1027 which is on the top right of the first user interface 1021 as the new user interface.

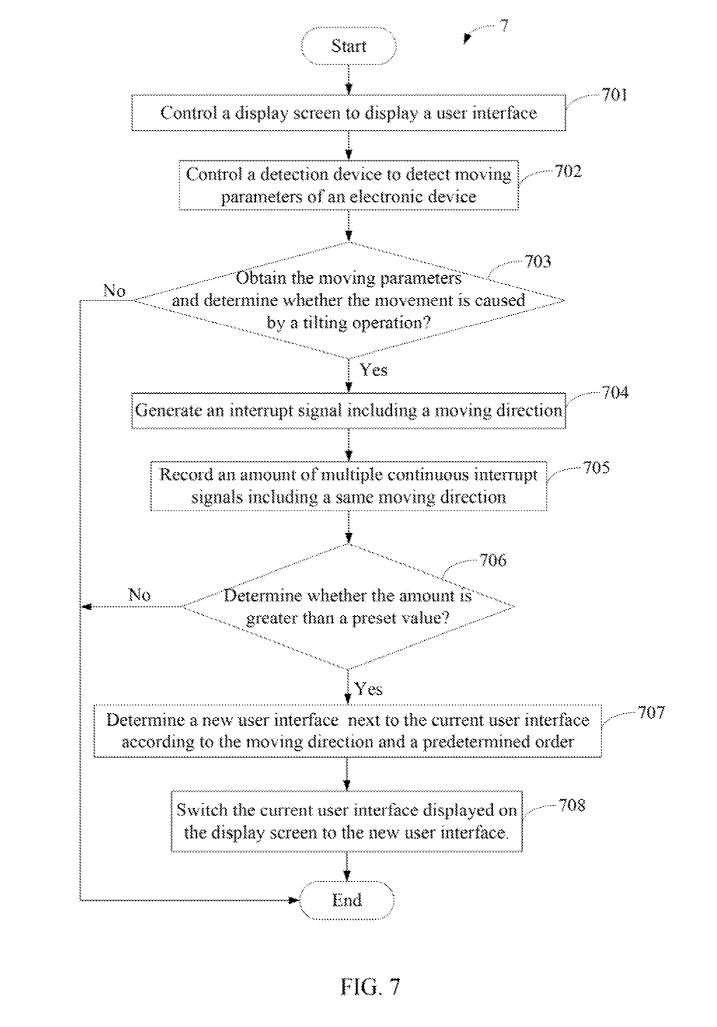

Referring to FIG. 7, a flowchart of a control method for displaying a user interface of an electronic device is presented in accordance with an example embodiment. The example method 7 is provided by way of example, as there are a variety of ways to carry out the method. The example method 7 described below can be carried out using the configurations illustrated in FIG. 1 for example, and various elements of these figures are referenced in explaining example method 7. Each block shown in FIG. 7 represents one or more processes, methods, or subroutines carried out in the example method 7. Furthermore, the illustrated order of blocks is by example only and the order of the blocks can be changed. The example method 7 can begin at block 701. Depending on the embodiment, additional steps can be added, others removed, and the ordering of the steps can be changed.

At block 701, a control module controls a display screen to display a user interface.

At block 702, the control module controls a detection device to detect movement parameters of an electronic device.

At block 703, an obtaining module obtains the movement parameters detected by the detection device and a determining module determines whether the movement of the electronic device is caused by a tilting operation. If the movement is caused by a tilting operation, block 704 is implemented. Otherwise, if the movement is not caused by a tilting operation, the flow is ended.

At block 704, the control module generates an interrupt signal including the movement direction.

At block 705, the control module records an amount of multiple continuous interrupt signals including a same movement direction.

At block 706, the determining module determines whether the amount of the multiple continuous interrupt signals including a same movement direction is more than a preset value within a second preset time. If the amount is more than the preset value within the second preset time, block 705 is implemented. Otherwise, if the amount is less than the preset value within the second preset time, the flow is ended.

At block 707, the determining module determines a new user interface next to the current user interface displayed on the display screen according to the movement direction and the predetermined order.

At block 708, the control module switches the current user interface displayed on the display screen to the new user interface.

With such a configuration, a current user interface can be switched as the electronic device is titled twice.

It should be emphasized that above-described embodiment of the present disclosure including any particular embodiments, are merely examples of implementations set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. An electronic device comprising:
a detection device configured to detect movement parameters of the electronic device, wherein the movement parameters comprise a movement direction of the electronic device;
at least one processor coupled to the detection device;
a display screen coupled to the at least one processor; and
a non-transitory storage device that pre-stores a series of instructions for user interfaces arranged in a predetermined order, and the storage device further stores one or more programs which, when executed by the at least one processor, cause the at least one processor to:
obtain the movement parameters detected by the detection device;
determine that the movement of the electronic device is caused by a tilting operation according to the obtained movement parameters;
generate, in response to the determination that the movement is caused by the tilting operation, an interrupt signal comprising the movement direction;
record an amount of multiple continuous interrupt signals comprising a same movement direction;
determine that the amount is more than a preset value within a first preset time;
determine, in response to the determination that the amount is more than a present value within a first present time, a new user interface next to a current user interface displayed on the display screen according to the movement direction and the predetermined order; and
switch the current user interface displayed on the display screen to the new user interface.

2. The electronic device according to claim 1, wherein the movement parameters further comprising a displacement relatives to a reference position of the electronic device, and the at least one processor determines that the movement of the electronic device is caused by a tilting operation according to the obtained movement parameters by:
determining that the displacement is greater than a preset displacement;
further determining, in response to the determination that the displacement is greater than the preset displacement, that the displacement changes to be less than the preset displacement within a second preset time; and
determining, in response to the determination that the displacement changes to be less than the preset displacement within the second preset time, the movement of the electronic device is caused by a tilting operation.

3. The electronic device according to claim 1, wherein the movement parameters further comprising a tilt angle relatives to a reference position on a plane of the electronic device, and the at least one processor determines that the movement of the electronic device is caused by a tilting operation according to the obtained movement parameters by:
determining that the tilt angle is greater than a preset angle;
further determining, in response to the determination that the tilt angle is greater than the preset angle, that the tilt angle changes to be less than the preset angle within a second preset time; and
determining, in response to the determination that the tilt angle changes to be less than the preset angle within the second preset time, the movement of the electronic device is caused by a tilting operation.

4. The electronic device according to claim 1, wherein the preset value is two.

5. The electronic device according to claim 1, wherein the at least one processor:
determines a user interface on the left side of the current user interface as the new user interface if the movement direction is to the left of the electronic device;
determines a user interface on the right side of the current user interface as the new user interface if the movement direction is to the right of the electronic device;
determines a user interface above the current user interface as the new user interface if the movement direction is to the top of the electronic device;
determines a user interface below the current user interface as the new user interface if the movement direction is to the bottom of the electronic device;
determines a user interface on the top right of the current user interface as the new user interface if the movement direction is to the top right of the electronic device;
determines a user interface on the top left of the current user interface as the new user interface if the movement direction is to the top left of the electronic device;
determines a user interface on the bottom right of the current user interface as the new user interface if the movement direction is to the bottom right of the electronic device; and
determines a user interface on the bottom left of the current user interface as the new user interface if the movement direction is to the bottom left of the electronic device.

6. The electronic device according to claim 1, wherein the at least one processor:
determines a user interface on the right side of the current user interface as the new user interface if the movement direction is to the left of the electronic device;
determines a user interface on the left side of the current user interface as the new user interface if the movement direction is to the right of the electronic device;
determines a user interface below the current user interface as the new user interface if the movement direction is to the top of the electronic device;
determines a user interface above the current user interface as the new user interface if the movement direction is to the bottom of the electronic device;
determines a user interface on the bottom left of the current user interface as the new user interface if the movement direction is to the top right of the electronic device;
determines a user interface on the bottom right of the current user interface as the new user interface if the movement direction is to the top left of the electronic device;
determines a user interface on the top left of the current user interface as the new user interface if the movement direction is to the bottom right of the electronic device; and
determines a user interface on the top right of the current user interface as the new user interface if the movement direction is to the bottom left of the electronic device.

7. The electronic device according to claim 1, wherein the detection device detects movement direction by detecting an acceleration direction of the electronic device.

8. A computer-implemented control method for displaying user interface of an electronic device being executed by a processor of the electronic device, the method comprising:
obtaining movement parameters detected by a detection device of the electronic device;
determining that the movement of the electronic device is caused by a tilting operation according to the obtained movement parameters, wherein the movement parameters comprise a movement direction of the electronic device;
generating, in response to the determination that the movement is caused by the tilting operation, an interrupt signal comprising the movement direction;
recording an amount of multiple continuous interrupt signals comprising a same movement direction;
determining that the amount is more than a preset value within a first preset time;
determining, in response to the determination that the amount is more than a present value within a first present time, a new user interface next to a current user interface displayed on the display screen according to the movement direction and a predetermined order of a series of instructions for user interfaces which are pre-stored in a storage device of the electronic device; and
switching the current user interface displayed on the display screen to the new user interface.

9. The method according to claim 8, wherein the movement parameters further comprising a displacement relatives to a reference position of the electronic device, and determining that the movement of the electronic device is caused by a tilting operation according to the obtained movement parameters comprising:
determining that the displacement is greater than a preset displacement;
further determining, in response to the determination that the displacement is greater than the preset displacement, that the displacement changes to be less than the preset displacement within a second preset time; and
determining, in response to the determination that the displacement changes to be less than the preset displacement within the second preset time, the movement of the electronic device is caused by a tilting operation.

10. The method according to claim 8, wherein the movement parameters further comprising a tilt angle relatives to a reference position on a plane of the electronic device, and determining that the movement of the electronic device is caused by a tilting operation according to the obtained movement parameters comprising:
determining that the tilt angle is greater than a preset angle;
further determining, in response to the determination that the tilt angle is greater than the preset angle, that the tilt angle changes to be less than the preset angle within a second preset time; and
determining, in response to the determination that the tilt angle changes to be less than the preset angle within the second preset time, the movement of the electronic device is caused by a tilting operation.

11. The method according to claim 8, wherein the preset value is two.

12. The method according to claim 8, wherein determining a new user interface next to a current user interface displayed on the display screen according to the movement direction and a predetermined order comprising:
if the movement direction is to the left of the electronic device, determining a user interface on the left side of the current user interface as the new user interface;
if the movement direction is to the right of the electronic device, determining a user interface on the right side of the current user interface as the new user interface;
if the movement direction is to the top of the electronic device, determining a user interface above the current user interface as the new user interface;
if the movement direction is to the bottom of the electronic device, determining a user interface below the current user interface as the new user interface;
if the movement direction is to the top right of the electronic device, determining a user interface on the top right of the current user interface as the new user interface;
if the movement direction is to the top left of the electronic device, determining a user interface on the top left of the current user interface as the new user interface;
if the movement direction is to the bottom right of the electronic device, determining a user interface on the bottom right of the current user interface as the new user interface; and
if the movement direction is to the bottom left of the electronic device, determining a user interface on the bottom left of the current user interface as the new user interface.

13. The method according to claim 8, wherein determining a new user interface next to a current user interface displayed on the display screen according to the movement direction and a predetermined order comprising:
if the movement direction is to the left of the electronic device, determining a user interface on the right side of the current user interface as the new user interface;
if the movement direction is to the right of the electronic device, determining a user interface on the left side of the current user interface as the new user interface;
if the movement direction is to the top of the electronic device, determining a user interface below the current user interface as the new user interface;
if the movement direction is to the bottom of the electronic device, determining a user interface above the current user interface as the new user interface;
if the movement direction is to the top right of the electronic device, determining a user interface on the bottom left of the current user interface as the new user interface;
if the movement direction is to the top left of the electronic device, determining a user interface on the bottom right of the current user interface as the new user interface;
if the movement direction is to the bottom right of the electronic device, determining a user interface on the top left of the current user interface as the new user interface; and
if the movement direction is to the bottom left of the electronic device, determining a user interface on top right the of the current user interface as the new user interface.

14. A non-transitory storage medium having stored thereon instructions that, when executed by a processor of an electronic device, causes the processor to perform a control method for displaying user interface, the method comprising:
obtaining movement parameters detected by a detection device of the electronic device;
determining that the movement of the electronic device is caused by a tilting operation according to the obtained movement parameters, wherein the movement parameters comprise a movement direction of the electronic device;
generating, in response to the determination that the movement is caused by the tilting operation, an interrupt signal comprising the movement direction;
recording an amount of multiple continuous interrupt signals comprising a same movement direction;
determining that the amount is more than a preset value within a first preset time;
determining, in response to the determination that the amount is more than a present value within a first present time, a new user interface next to a current user interface displayed on the display screen according to the movement direction and a predetermined order of a series of instructions for user interfaces which are pre-stored in a storage device of the electronic device; and
switching the current user interface displayed on the display screen to the new user interface.

15. The non-transitory storage medium according to claim 14, wherein the movement parameters further comprising a displacement relatives to a reference position of the electronic device, and determining that the movement of the electronic device is caused by a tilting operation according to the obtained movement parameters comprising:
determining that the displacement is greater than a preset displacement;
further determining, in response to the determination that the displacement is greater than the preset displacement, that the displacement changes to be less than the preset displacement within a second preset time; and
determining, in response to the determination that the displacement changes to be less than the preset displacement within the second preset time, the movement of the electronic device is caused by a tilting operation.

16. The non-transitory storage medium according to claim 14, wherein the movement parameters further comprising a tilt angle relatives to a reference position on a plane of the electronic device, and determining that the movement of the electronic device is caused by a tilting operation according to the obtained movement parameters comprising:
determining that the tilt angle is greater than a preset angle;
further determining, in response to the determination that the tilt angle is greater than the preset angle, that the tilt angle changes to be less than the preset angle within a second preset time; and
determining, in response to the determination that the tilt angle changes to be less than the preset angle within the second preset time, the movement of the electronic device is caused by a tilting operation.

17. The non-transitory storage medium according to claim 14, wherein the preset value is two.

18. The non-transitory storage medium according to claim 14, wherein determining a new user interface next to a current user interface displayed on the display screen according to the movement direction and a predetermined order comprising:
if the movement direction is to the left of the electronic device, determining a user interface on the left side of the current user interface as the new user interface;
if the movement direction is to the right of the electronic device, determining a user interface on the right side of the current user interface as the new user interface;
if the movement direction is to the top of the electronic device, determining a user interface above the current user interface as the new user interface;
if the movement direction is to the bottom of the electronic device, determining a user interface below the current user interface as the new user interface;
if the movement direction is to the top right of the electronic device, determining a user interface on the top right of the current user interface as the new user interface;
if the movement direction is to the top left of the electronic device, determining a user interface on the top left of the current user interface as the new user interface;
if the movement direction is to the bottom right of the electronic device, determining a user interface on the bottom right of the current user interface as the new user interface; and
if the movement direction is to the bottom left of the electronic device, determining a user interface on the bottom left of the current user interface as the new user interface.

19. The non-transitory storage medium according to claim 14, wherein determining a new user interface next to a current user interface displayed on the display screen according to the movement direction and a predetermined order comprising:
if the movement direction is to the left of the electronic device, determining a user interface on the right side of the current user interface as the new user interface;
if the movement direction is to the right of the electronic device, determining a user interface on the left side of the current user interface as the new user interface;
if the movement direction is to the top of the electronic device, determining a user interface below the current user interface as the new user interface;
if the movement direction is to the bottom of the electronic device, determining a user interface above the current user interface as the new user interface;
if the movement direction is to the top right of the electronic device, determining a user interface on the bottom left of the current user interface as the new user interface;
if the movement direction is to the top left of the electronic device, determining a user interface on the bottom right of the current user interface as the new user interface;
if the movement direction is to the bottom right of the electronic device, determining a user interface on the top left of the current user interface as the new user interface; and
if the movement direction is to the bottom left of the electronic device, determining a user interface on top right the of the current user interface as the new user interface.
